(19) United States
(12) Patent Application Publication
(10) Pub. No.: US 2025/0258267 A1
(43) Pub. Date: Aug. 14, 2025

(54) GLOBAL NAVIGATION SATELLITE SYSTEM (GNSS) AGNOSTIC MULTINODE TIMING (GAMT) SYSTEM AND METHOD

(71) Applicant: Rockwell Collins, Inc., Cedar Rapids, IA (US)

(72) Inventors: Eric J. Loren, North Liberty, IA (US); William B. Sorsby, Cedar Rapids, IA (US); Tj T. Kwon, Marion, IA (US); James A. Stevens, Lucas, TX (US)

(21) Appl. No.: 18/440,707

(22) Filed: Feb. 13, 2024

(51) Int. Cl. G01S 5/02; G01S 5/10

(52) U.S. Cl. CPC G01S 5/0226; G01S 5/10

(57) ABSTRACT

A system includes a first node configured to, based at least on (1) arrival times associated with at least three of at least three transmittals and (2) information associated with any time adjustments to at least three transmittals, determine (a) relative positions of second, third, and fourth nodes relative to a position of the first node and (b) relative clock times of second, third, and fourth node clocks relative to the first node clock.

### BACKGROUND

Currently, communications systems typically use coordinated time for messaging due to time slots and transmission security (TRANSEC), and sometimes due to antenna pointing and spatial tracking. Another complication in communication systems is the frequency offset of signals due to Doppler shifts and clock frequency offsets which often can limit performance and increase processing resources. Some approaches use global navigation satellite systems (GNSSs, such as a global positioning system (GPS)) and explicit data transfers, but such approaches have disadvantages.

### SUMMARY

In one aspect, embodiments of the inventive concepts disclosed herein are directed to a system. The system may include a first node of a network. The network includes nodes including the first node having a first node clock, a second node having a second node clock, a third node having a third node clock, and a fourth node having a fourth node clock. Each node of the network includes at least one antenna and at least one processor. The first, second, third, and fourth nodes are configured to communicate with each other during cycles having time periods. The time periods include a first time period and subsequent time periods. The first node is configured to: receive at least three transmittals, each of the at least three transmittals being from one of the second, third, and fourth nodes; and based at least on (1) arrival times associated with at least three of the at least three transmittals and (2) information associated with any time adjustments to the at least three transmittals, determine (a) relative positions of the second, third, and fourth nodes relative to a position of the first node and (b) relative clock times of the second, third, and fourth node clocks relative to the first node clock.

In a further aspect, embodiments of the inventive concepts disclosed herein are directed to a method. The method may include: receiving, by a first node of a network comprising the first node and second, third, and fourth nodes, at least three transmittals, each of the at least three transmittals being from one of the second, third, and fourth nodes, the first node having a first node clock, the second node having a second node clock, the third node having a third node clock, and the fourth node having a fourth node clock, each node of the network comprising at least one antenna and at least one processor, wherein the first, second, third, and fourth nodes are configured to communicate with each other during cycles having time periods, the time periods including a first time period and subsequent time periods; and based at least on (1) arrival times associated with at least three of the at least three transmittals and (2) information associated with any time adjustments to the at least three transmittals, determining, by the first node, (a) relative positions of the second, third, and fourth nodes relative to a position of the first node and (b) relative clock times of the second, third, and fourth node clocks relative to the first node clock.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a view of an exemplary embodiment of a system according to the inventive concepts disclosed herein.

FIG. 2 is a view of an exemplary embodiment of the system of FIG. 1 according to the inventive concepts disclosed herein.

FIG. 3 is a view of a diagram of one transmittal of an exemplary embodiment of the system of FIG. 1 according to the inventive concepts disclosed herein.

FIG. 4 is a view of a diagram of another transmittal of an exemplary embodiment of the system of FIG. 1 according to the inventive concepts disclosed herein.

FIG. 5 is a set of equations associated with an exemplary embodiment of the system of FIG. 1 according to the inventive concepts disclosed herein.

FIG. 6 is a system of linear equations and a pseudo inverse matrix associated with an exemplary embodiment of the system of FIG. 1 according to the inventive concepts disclosed herein.

FIG. 7 is a table associated with an exemplary embodiment of the system of FIG. 1 according to the inventive concepts disclosed herein.

FIGS. 8A, 8B, and 8C are views of three sets of a first node and one neighbor node, with each set during a different time period, of an exemplary embodiment of the system of FIG. 1 according to the inventive concepts disclosed herein.

FIG. 9 is a system of linear equations and a pseudo inverse matrix associated with FIGS. 8A, 8B, and 8C according to the inventive concepts disclosed herein.

FIGS. 10A, 10B, and 10C are views of three sets of a first node and two neighbor nodes of an exemplary embodiment of the system of FIG. 1 according to the inventive concepts disclosed herein.

FIG. 11 is a system of linear equations and a pseudo inverse matrix associated with FIGS. 10A, 10B, and 10C according to the inventive concepts disclosed herein.

FIG. 12 is a diagram of an exemplary embodiment of a method according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and they should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features which may not necessarily be expressly described or inherently present in the instant disclosure.

Broadly, embodiments of the inventive concepts disclosed herein are directed to a method and a system including a first node (e.g., of a network) configured to, based at least on (1) arrival times associated with at least three of at least three transmittals and (2) information associated with any time adjustments to at least three transmittals, determine (a) relative positions of second, third, and fourth nodes relative to a position of the first node and (b) relative clock times of second, third, and fourth node clocks relative to the first node clock.

Some embodiments utilize a framework (e.g., an acquisition-based messaging framework or a data-based messaging framework) that conveys neighbor information through transmission time adjustments. In some embodiments, GAMT may use at least one reference cycle (e.g., at least one initial reference cycle of a network of participating nodes, such as when a network of nodes using GAMT is formed, and/or at least one optional subsequent (e.g., which may be uniformly or non-uniformly spaced) reference cycle, which may be used periodically, such as if network membership and/or participation changes and/or if some threshold number of cycles have passed without sufficient participation by a threshold number of nodes). For example, a reference cycle may be accomplished with a common protocol (e.g., a protocol used in common by participating nodes of a network) that steps through each of the nodes as a reference node (e.g., such that any node acting as reference node during a given time period (e.g., during a given frame of the given time period) does not adjust said node's nominal transmission time) at a different time period. Each node may adjust its own transmission time according to that reference node during a given time period. The messages may be broadcasted, and all participating and/or member nodes may receive the messages at arrival times that depend upon the transmit time adjustment(s), a propagation delay, and clock times of the transmitters and receivers. For example, a transmitting node that transmits a transmittal that is “time adjusted” may refer to when the transmitting node transmits the transmittal with an adjustment (e.g., by an time offset earlier or later than a nominal transmit time according to a clock of the transmitting node) made to the transmitting node's clock time such that the transmitting node's transmittal time is adjusted based on the arrival time of a transmission from another node (e.g., a given node acting as a reference node at a given time). For example, each node can process (e.g., using hardware, such as processor(s)) a collection of arrival times using a system(s) of linear equation operations to determine ranges (and/or relative positions) between all participant nodes and relative time of all participant nodes.

Some embodiments may provide relative range, relative position, relative time, and/or relative frequency offset(s) between all participating nodes. Some embodiments may use acquisition-based messaging, which can typically provide an order of magnitude improvement over traditional explicit data transfers, for example, that can effectively transfer about 17 bits acquisition-based message. For example, such a acquisition-based messaging approach may mate well with ultra-sensitive acquisition frameworks (e.g., for use with anti-jamming (AJ) communications, range finding transmissions, and/or low observability (LO) communications) for operation at ultra-low signal-to-noise ratios (SNRs).

Some embodiments may provide relative four-dimensional (4D) space-time information of neighbor nodes. Some embodiments may provide a range between each link (e.g., as a relative network topology). Some embodiments may provide neighbor clock information (e.g., neighbor time information and/or neighbor oscillator offsets).

Some embodiments may be used for GNSS-agnostic multinode timing (GAMT, which may be pronounced “gamut”). Some embodiments may provide relative four-dimensional (4D) space-time information of neighbor nodes without GNSS information or platform information; though, some embodiments may be assumed to use crude time information (e.g., two milliseconds (ms)) for determining time periods (e.g. time slots) to transmit as a reference node in. Some embodiments include a relative time and distance technique that has no direct reliance on GNSS (e.g., GPS) time or correct time; however, many systems require reasonably consistent network time to communicate, often times multiple milliseconds. Some embodiments, which include use of GAMT and/or aspects of GAMT, work for two or more nodes in a network. For example, where a network includes two nodes, one or both of the two nodes can use GAMT to determine a relative range (e.g., a one-dimensional (1-D) range) to the other node of the two nodes. For example, where a network includes three nodes, one, some, or all of the three nodes can use GAMT to determine a relative position on a surface (e.g., a two-dimensional (2-D) surface). For example, where a network includes at least three nodes, one, some, or all of the at least three nodes can use GAMT to determine a relative position in space (e.g., three-dimensional (3-D) space).

Some embodiments may be used with any suitable antenna type (e.g., directional or non-directional antennas). For example, some embodiments may be well-suited to use with non-directional antennas.

Some embodiments may use relative messaging. For example, relative messaging may be effectively much smaller than absolute information. For example, small effective packet sizes may be well-suited for acquisition-based data transfers. For example, relative messaging may not compromise platform with absolute position message exposure.

Some embodiments may work well with ultra-sensitive acquisition framework, such as for operation at ultra-low SNR.

Some embodiments may use any suitable network protocol, such as Node Reference Protocol. For example, nodes (e.g., participating and/or member nodes) of a network may use Node Reference Protocol in common, and Node Reference Protocol may define the reference node ordering, for example, where non-reference node transmissions may be time adjusted according to a given reference node for a given time period. For example, for an exemplary four-node network, a cycle of Node 1, then Node 2, then Node 3, and then Node 4 acting as the reference node performed over a cycle duration (e.g., any suitable cycle duration, such as 4 seconds), and such order may be repeated in subsequent cycles. For example, all transmitters may adjust their transmit time according to protocol's reference node, and no transmit adjustment is necessary when a reference node is a transmitting node, itself. Each transmission may be received by some or all nodes (e.g. where a transmission is transmitted as a broadcast equivalent). A frame (e.g., packet frame, data frame, or preamble frame) may be composed of (e.g., composed only of) known symbols. Information may be effectively transferred through transmit time adjustments and determined through the node's collective arrival time characteristics from all nodes in protocol.

Some embodiments may include solving a system of linear equations (e.g., using any suitable approach, such as with a pseudo-inverse matrix), which may provide: a participant node topology; all participants' relative times; relative oscillator offsets, which can be determined from deltas in relative times (e.g., with ˜ 1/16 ppm accuracy for 16 Msps chipping rate (e.g., which may be further enhanced with successive measurements)); compatible with a the SNR of acquisition; no need for GNSS input; no need for directional radiation; and/or no need for precise knowledge of time (e.g., a crude time may be used).

In some embodiments, GAMT may be different from and have advantages over two-way timing & ranging (TWTR). For example, while TWTR and a two-node application of GAMT both use two nodes, two-node GAMT-applications use less digital reporting of information in a payload; rather, two-node GAMT applications pass information via a preamble and/or through a time (e.g., a time of transmission and/or a time of arrival) of an adjusted transmission in a frame. Similarly, in some embodiments, GAMT may be different from and have similar advantages over N-ary two-way ranging (N-TWR). For example, a significant difference between GAMT and N-TWR is that N-TWR works based off of skewing the frequency of transmission of multiple nodes, as opposed to GAMT. Additionally, N-TWR is sensitive to temperature of nodes, whereas GAMT may be temperature insensitive. Similarly, GAMT is different from Time Difference of Arrival (TDoA), which uses arrival times to calculate positions. Additionally, TDoA has to explicitly exchange time information, whereas GAMT uses transmissions having time adjustments to transmitting nodes' (e.g. transmitting non-reference nodes') transmittal times such that the time adjustments can be obtained, for example, during a reference cycle.

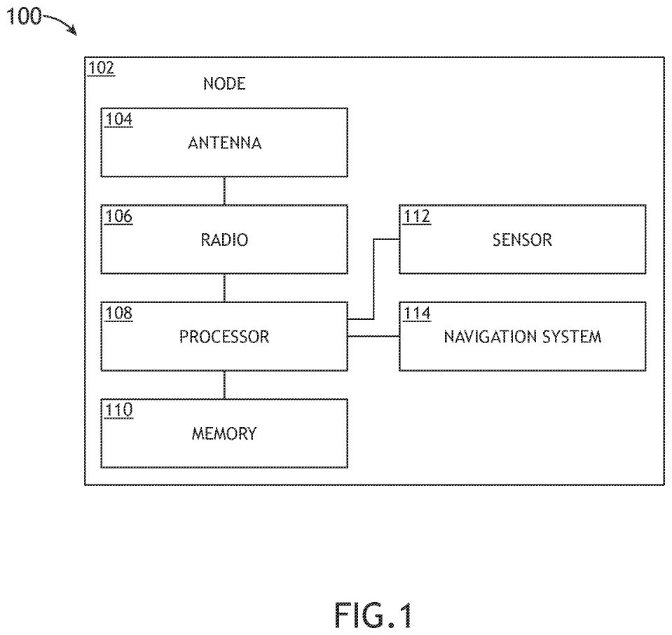

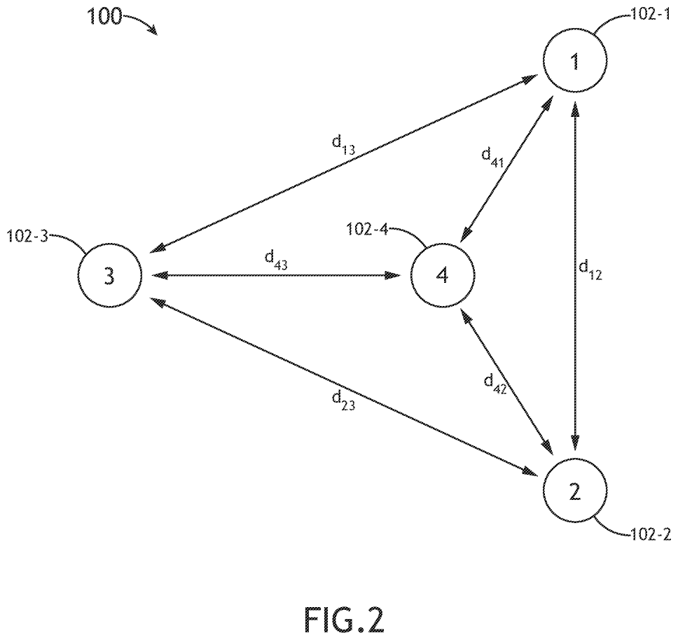

Referring now to FIGS. 1-2, an exemplary embodiment of a system according to the inventive concepts disclosed herein is depicted. The system may be implemented as any suitable system, such as a network 100 (e.g., an RF-based network, a wireless network, a mobile ad hoc network (MANET), a mobile network (e.g., a 4G or a 5G network), or a sonar network). The network 100 may include a plurality of nodes 102 (e.g., nodes 102-1, 102-2, 102-3, 102-4, and/or at least one other node (not shown)), some or all of which may be communicatively coupled at any given time. In some embodiments, the network 100 may include at least two nodes 102, and one, some, or all of the at least two nodes 102 may be configured to use GAMT to determine at least one relative range to and/or at least one relative position of at least one other node 102 of the at least two nodes 102 of the network 100.

Each node 102 (e.g., a first node 102-1, a second node 102-2, a third node 102-3, or a fourth node 102-4) may be any suitable node, such as a vehicle (e.g., an aircraft (e.g., a manned aircraft or a UAV (e.g., an attritable UAV)), a watercraft, a submersible craft, an automobile, a spacecraft, a satellite, and/or a train), a manpack, a projectile, a mobile device (e.g., a mobile phone and/or a laptop computing device), a building, a structure, a sensor, or a platform (e.g., a radio tower). As shown in FIG. 1, each node 102 may include at least one antenna 104, at least one radio 106 (e.g., at least one software-defined radio (SDR)), at least one processor 108, at least one memory 110, at least one sensor 112, and/or at least one navigation system 114 (e.g., at least one GNSS device (e.g., at least one GPS device), at least one altimeter, at least one radar, at least one lidar, at least one electro-optical/infrared (EO/IR) sensor, at least one magnetic anomaly, at least one terrain database, at least one distance measuring equipment (DME), at least one tactical air navigation system (TACAN), at least one long-range navigation (LORAN) system, and/or at least one inertial navigation system (e.g., at least one Ring Laser Gyro, at least one Inertial Measurement Unit (IMU), at least one Fiber Optic Gyro (FOG), and/or at least one Micro-Electromechanical System (MEMS)), some or all of which may be communicatively coupled at any given time. For example, each radio 106 may be configured to communicate via any suitable waveform(s). In some embodiments, the radio 106 includes one or more of the antennas 104, one or more processors, and/or one or more clocks. For example, the at least one antenna 104, the at least one radio 106, the at least one processor 108, the at least one memory 110, the at least one sensor 112, and/or the at least one navigation system 114 may be configured to perform (e.g., collectively perform if more than one radio, more than one antenna, more than one radio, more than one processor, more than one memory, more than one sensor, and/or more than one navigation system) any or all of the operations disclosed throughout. For example, the at least one processor 108 may be configured to perform (e.g., collectively perform if more than one processor) any or all of the operations disclosed throughout. The at least one processor 108 may be configured to run various software applications or computer code stored (e.g., maintained) in a non-transitory computer-readable medium (e.g., memory 110) and configured to execute various instructions or operations. For example, the at least one processor 108 may include at least one central processing unit (CPU), at least one graphics processing unit (GPU), at least one field-programmable gate array (FPGA), at least one application specific integrated circuit (ASIC), at least one digital signal processor, at least one data processing unit (DPU), at least one virtual machine (VM) running on at least one processor, and/or the like configured to perform (e.g., collectively perform) any of the operations disclosed throughout. For example, the at least one processor 108 may include a CPU and/or an FPGA configured to perform (e.g., collectively perform) any of the operations disclosed throughout.

In some embodiments, the network 100 may include nodes 102 (e.g., two nodes 102, three nodes 102, four nodes 102 (e.g., 102-1, 102-2, 102-3, 102-4 as exemplarily shown in FIG. 2), five nodes, . . . , one hundred nodes, etc.). The nodes 102 may include the first node 102-1 having a first node clock, a second node 102-2 having a second node clock, a third node 102-3 having a third node clock, and a fourth node 102-4 having a fourth node clock. Each node 102 (e.g., the first node 102-1, the second node 102-2, the third node 102-3, or the fourth node 102-4) of the network 100 may include at least one antenna 104 and at least one processor 108. The first, second, third, and fourth nodes 102-1, 102-2, 102-3, 102-4 may be configured to communicate with each other during cycles, with each cycle having time periods (e.g., time slots). The time periods may include a first time period and subsequent time periods. In some embodiments, where a network 102 has a size of n (e.g., where n is a natural number greater than or equal to 2) nodes 102, the n nodes 102 may be configured to communicate with each other during cycles, with each cycle having at least n time periods (e.g., time slots).

In some embodiments, the first node 102-1 may be configured to: receive at least three transmittals (e.g., at least twelve transmittals), each of the at least three transmittals (e.g., the at least twelve transmittals) being from one of the second, third, and fourth nodes 102-2, 102-3, 102-4; and/or based at least on (1) arrival times associated with at least three of the at least three transmittals (e.g., the at least twelve transmittals) and (2) information associated with any time adjustments to the at least three transmittals (e.g., the at least twelve transmittals), determine (a) relative positions of the second, third, and fourth nodes 102-2, 102-3, 102-4 relative to a position of the first node 102-1 and (b) relative clock times of the second, third, and fourth node clocks relative to the first node clock.

In some embodiments, the first node 102-1 may be configured to: during one period of a first time period, a second time period, a third time period, or a fourth time period, transmit a first first-node transmittal at a first first-node time, wherein the first first-node transmittal has no time adjustment to the first node clock, wherein a first cycle of time periods comprises the first, second, third, and fourth time periods, the first, second, third, and fourth time periods occurring in any order (e.g., any order known to the nodes 102-1, 102-2, 102-3, 102-4). In some embodiments, the first cycle of time periods may optionally further comprise at least one additional first cycle time period located in time in any relation to the first, second, third, and fourth time periods.

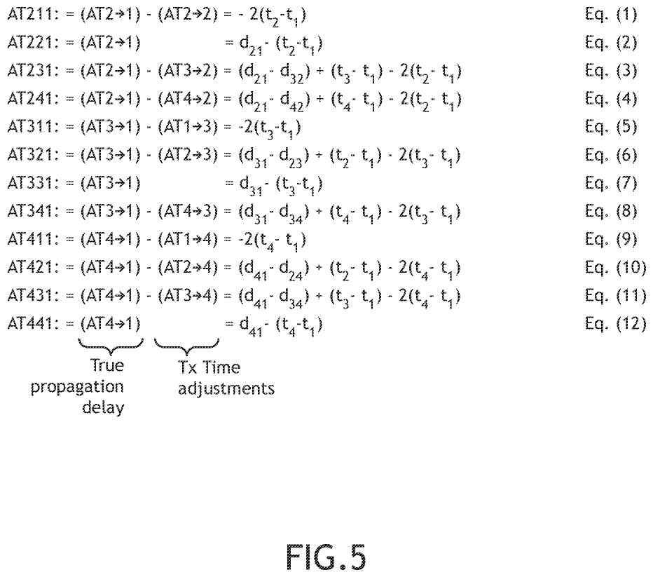

In some embodiments, the first node 102-1 may be configured to, during one period of the first time period, a second time period, a third time period, or a fourth time period, receive a first transmittal (e.g., not to be confused with the first first-node transmittal, discussed above) at a first arrival time, the first transmittal having been transmitted from the second node 102-2 with no time adjustment to the second node clock, wherein a first cycle of time periods comprises the first, second, third, and fourth time periods, the first, second, third, and fourth time periods occurring in any order (e.g., any order known to the nodes 102-1, 102-2, 102-3, 102-4). In some embodiments, where the one period is the second time period and where an exemplary size of the network 100 is four nodes 102, receipt of the first transmittal may provide information of a true propagation delay between the first node 102-1 and the second node 102-2 based at least on the equation for AT221 from Eq. (2) of FIG. 5.

In some embodiments, the first node 102-1 may be configured to, during another period of the first, second, third, or fourth time periods, receive a second transmittal at a second arrival time, the second transmittal having been transmitted from the third node 102-3 with no time adjustment to the third node clock. In some embodiments, where the other period is the third time period and where an exemplary size of the network 100 is four nodes 102, receipt of the second transmittal may provide information of a true propagation delay between the first node 102-1 and the third node 102-3 based at least on the equation for AT331 from Eq. (7) of FIG. 5.

In some embodiments, the first node 102-1 may be configured to, during a further period of the first, second, third, or fourth time periods, receive a third transmittal at a third arrival time, the third transmittal having been transmitted from the fourth node 102-4 with no time adjustment to the fourth node clock. In some embodiments, where the further period is the fourth time period and where an exemplary size of the network 100 is four nodes 102, receipt of the second transmittal may provide information of a true propagation delay between the first node 102-1 and the fourth node 102-4 based at least on the equation for AT441 from Eq. (12) of FIG. 5.

In some embodiments, the first node 102-1 may be configured to, during one period of a fifth time period, a sixth time period, a seventh time period, or an eighth time period: receive a fourth transmittal at a fourth arrival time, the fourth transmittal having been transmitted from the second node 102-2 with the second node clock time adjusted (e.g., by a transmit time adjustment, which may be calculated based at least on performance of at least one mathematical operation (e.g., at least one algebra operation (e.g., at least one linear algebra operation)) at least on the equation for AT211 from Eq. (1) and/or at least one other equation of Equations (1)-(12) of FIG. 5, where the one period is the fifth time period and where an exemplary size of the network 100 is four nodes 102) for the first node clock; receive a fifth transmittal at a fifth arrival time, the fifth transmittal having been transmitted from the third node 102-3 with the third node clock time adjusted (e.g., by a transmit time adjustment, which may be calculated based at least on performance of at least one mathematical operation (e.g., at least one algebra operation (e.g., at least one linear algebra operation)) at least on the equation for AT311 from Eq. (5) and/or at least one other equation of Equations (1)-(12) of FIG. 5, where the one period is the fifth time period and where an exemplary size of the network 100 is four nodes 102) for the first node clock; and/or receive a sixth transmittal at a sixth arrival time, the sixth transmittal having been transmitted from the fourth node 102-4 with the fourth node clock time adjusted (e.g., by a transmit time adjustment, which may be calculated based at least on performance of at least one mathematical operation (e.g., at least one algebra operation (e.g., at least one linear algebra operation)) at least on the equation for AT411 from Eq. (9) and/or at least one other equation of Equations (1)-(12) of FIG. 5, where the one period is the fifth time period and where an exemplary size of the network 100 is four nodes 102) for the first node clock, wherein the fourth, fifth, and sixth transmittals occur in any order (e.g., any order known to the nodes 102-1, 102-2, 102-3, 102-4), wherein a second cycle of time periods comprises the fifth, sixth, seventh, and eighth time periods, the fifth, sixth, seventh, and eighth time periods occurring in any order (e.g., any order known to the nodes 102-1, 102-2, 102-3, 102-4). In some embodiments, the second cycle of time periods may optionally further comprise at least one additional second cycle time period located in time in any relation to the fifth, sixth, seventh, and eighth time periods.

In some embodiments, the first node 102-1 may be configured to, during another period of the fifth, sixth, seventh, or eighth time periods: receive a seventh transmittal at a seventh arrival time, the seventh transmittal having been transmitted from the second node 102-2 with no time adjustment to the second node clock; receive an eighth transmittal at an eighth arrival time, the eighth transmittal having been transmitted from the third node 102-3 with the third node clock time adjusted (e.g., by a transmit time adjustment, which may be calculated based at least on performance of at least one mathematical operation (e.g., at least one algebra operation (e.g., at least one linear algebra operation)) at least on the equation for AT321 from Eq. (6) and/or at least one other equation of Equations (1)-(12) of FIG. 5, where the other period is the sixth time period and where an exemplary size of the network 100 is four nodes 102) for the second node clock; and/or receive a ninth transmittal at a ninth arrival time, the ninth transmittal having been transmitted from the fourth node 102-4with the fourth node clock time adjusted (e.g., by a transmit time adjustment, which may be calculated based at least on performance of at least one mathematical operation (e.g., at least one algebra operation (e.g., at least one linear algebra operation)) at least on the equation for AT421 from Eq. (10) and/or at least one other equation of Equations (1)-(12) of FIG. 5, where the other period is the sixth time period and where an exemplary size of the network 100 is four nodes 102) for the second node clock, wherein the seventh, eighth, and ninth transmittals occur in any order (e.g., any order known to the nodes 102-1, 102-2, 102-3, 102-4).

In some embodiments, the first node 102-1 may be configured to, during a further period of the fifth, sixth, seventh, or eighth time periods: receive a tenth transmittal at a tenth arrival time, the tenth transmittal having been transmitted from the second node 102-2 with the second node clock time adjusted (e.g., by a transmit time adjustment, which may be calculated based at least on performance of at least one mathematical operation (e.g., at least one algebra operation (e.g., at least one linear algebra operation)) at least on the equation for AT231 from Eq. (3) and/or at least one other equation of Equations (1)-(12) of FIG. 5, where the further period is the seventh time period and where an exemplary size of the network 100 is four nodes 102) for the third node clock; receive an eleventh transmittal at an eleventh arrival time, the eleventh transmittal having been transmitted from the third node 102-3 with no time adjustment to the third node clock; and/or receive a twelfth transmittal at a twelfth arrival time, the twelfth transmittal having been transmitted from the fourth node 102-4 with the fourth node clock time adjusted (e.g., by a transmit time adjustment, which may be calculated based at least on performance of at least one mathematical operation (e.g., at least one algebra operation (e.g., at least one linear algebra operation)) at least on the equation for AT431 from Eq. (11) and/or at least one other equation of Equations (1)-(12) of FIG. 5, where the further period is the seventh time period and where an exemplary size of the network 100 is four nodes 102) for the third node clock, wherein the tenth, eleventh, and twelfth transmittals occur in any order (e.g., any order known to the nodes 102-1, 102-2, 102-3, 102-4).

In some embodiments, the first node 102-1 may be configured to, during an additional period of the fifth, sixth, seventh, or eighth time periods: receive a thirteenth transmittal at a thirteenth arrival time, the thirteenth transmittal having been transmitted from the second node 102-2 with the second node clock time adjusted (e.g., by a transmit time adjustment, which may be calculated based at least on performance of at least one mathematical operation (e.g., at least one algebra operation (e.g., at least one linear algebra operation)) at least on the equation for AT241 from Eq. (4) and/or at least one other equation of Equations (1)-(12) of FIG. 5, where the additional period is the eighth time period and where an exemplary size of the network 100 is four nodes 102) for the fourth node clock; receive a fourteenth transmittal at a fourteenth arrival time, the fourteenth transmittal having been transmitted from the third node 102-3 with the third node clock time adjusted (e.g., by a transmit time adjustment, which may be calculated based at least on performance of at least one mathematical operation (e.g., at least one algebra operation (e.g., at least one linear algebra operation)) at least on the equation for AT341 from Eq. (8) and/or at least one other equation of Equations (1)-(12) of FIG. 5, where the additional period is the eighth time period and where an exemplary size of the network 100 is four nodes 102) for the fourth node clock; and/or receive a fifteenth transmittal at a fifteenth arrival time, the fifteenth transmittal having been transmitted from the fourth node 102-4 with no time adjustment to the fourth node clock, wherein the thirteenth, fourteenth, and fifteenth transmittals occur in any order (e.g., any order known to the nodes 102-1, 102-2, 102-3, 102-4).

In some embodiments, the at least twelve transmittals are the fourth, fifth, sixth, seventh, eighth, ninth, tenth, eleventh, twelfth, thirteenth, fourteenth, and fifteenth transmittals.

In some embodiments, the first node 102-1 may be configured to: based at least on (1) at least three of the fourth, fifth, sixth, seventh, eighth, ninth, tenth, eleventh, twelfth, thirteenth, fourteenth, and fifteenth arrival times and (2) information associated with any time adjustment to one of the second, third, and fourth node clocks for each of at least three of the fourth, fifth, sixth, seventh, eighth, ninth, tenth, eleventh, twelfth, thirteenth, fourteenth, and fifteenth transmittals, determine (a) the relative positions of the second, third, and fourth nodes relative to the position of the first node and (b) the relative clock times of the second, third, and fourth node clocks relative to the first node clock.

For example, the at least three of the fourth, fifth, sixth, seventh, eighth, ninth, tenth, eleventh, twelfth, thirteenth, fourteenth, and fifteenth arrival times may be the seventh, eleventh, and fifteenth arrival times, and the at least three of the fourth, fifth, sixth, seventh, eighth, ninth, tenth, eleventh, twelfth, thirteenth, fourteenth, and fifteenth transmittals may be the seventh, eleventh, and fifteenth transmittals.

For example, the at least three of the fourth, fifth, sixth, seventh, eighth, ninth, tenth, eleventh, twelfth, thirteenth, fourteenth, and fifteenth arrival times may be the fourth, fifth, seventh, eighth, tenth, and eleventh arrival times, and the at least three of the fourth, fifth, sixth, seventh, eighth, ninth, tenth, eleventh, twelfth, thirteenth, fourteenth, and fifteenth transmittals may be the fourth, fifth, seventh, eighth, tenth, and eleventh transmittals.

For example, the at least three of the fourth, fifth, sixth, seventh, eighth, ninth, tenth, eleventh, twelfth, thirteenth, fourteenth, and fifteenth arrival times may be the fourth, fifth, sixth, seventh, eighth, ninth, tenth, eleventh, twelfth, thirteenth, fourteenth, and fifteenth arrival times, and the at least three of the fourth, fifth, sixth, seventh, eighth, ninth, tenth, eleventh, twelfth, thirteenth, fourteenth, and fifteenth transmittals may be the fourth, fifth, sixth, seventh, eighth, ninth, tenth, eleventh, twelfth, thirteenth, fourteenth, and fifteenth transmittals.

In some embodiments, the first node 102-1 may be further configured to: based at least on the relative positions and the relative clock times, at least one of (a) output instructions to adjust communication parameters (e.g., for pointing directional antennas, for electronic beam steering, and/or for routing traffic via relays) of the first node 102-1, (b) output instructions to adjust operational parameters of at least one of at least one sub-system (e.g., navigation system 114) or at least one sensor 112 of the first node 102-2, (c) output instructions to display at least one graphical image including information of the at least one of the relative positions or the relative clock times, (d) output instructions to navigate the first node 102-1, (e) output instructions to communicate with the second node 102-2, the third node 102-3, fourth node 102-4, and/or another node 102 of the network 100, (f) authenticate position information obtained from at least one navigation system 114, (g) authenticate time information obtained from at least one time system (e.g., GNSS (e.g., GPS)), (h) output instructions to the second node 102-2, the third node 102-3, the fourth node 102-4, and/or the other node 102 of the network 100 to support controlling communications with the first node 102 through the second node 102-2, the third node 102-3, the fourth node 102-4, and/or the other node 102, (i) output a position location information (PLI) message, (j) output audio data including information of the at least one of the relative positions or the relative clock times, or (k) output information of at least one of position (e.g., an absolute position; e.g., a 3-D or 4-D position) or time (e.g., using Network Time Protocol (NTP) or Precision Time Protocol (PTP)), the information based at least on at least one of the relative positions or the relative clock times. In some embodiments, the network 100 further comprises the other node 102.

In some embodiments, each of the fourth, fifth, sixth, seventh, eighth, ninth, tenth, eleventh, twelfth, thirteenth, fourteenth, and fifteenth arrival times depends on (a) a propagation delay of a corresponding transmittal of the fourth, fifth, sixth, seventh, eighth, ninth, tenth, eleventh, twelfth, thirteenth, fourteenth, and fifteenth transmittals and (b) any time adjustment to one clock of the second, third, or fourth node clocks of said corresponding transmittal of the fourth, fifth, sixth, seventh, eighth, ninth, tenth, eleventh, twelfth, thirteenth, fourteenth, and fifteenth transmittals.

In some embodiments, each of the fourth, fifth, sixth, seventh, eighth, ninth, tenth, eleventh, twelfth, thirteenth, fourteenth, and fifteenth transmittals is or includes a frame (e.g., a data frame or an acquisition frame). In some embodiments, each frame includes (e.g., only includes) known symbols.

In some embodiments, the first node 102-1 may be further configured to: perform operations (e.g., mathematical operations; e.g., using at least one matrix (e.g., a pseudo inverse matrix)) to solve a system of linear equations to determine (a) the relative positions and (b) the relative clock times.

In some embodiments, the first node 102-1 lacks a reliable GNSS (e.g., GPS) input (e.g., at least for a time interval spanning a duration to complete receptions of the at least three transmittals).

In some embodiments, the first node 102-1 lacks any GNSS input (e.g., at least for a time interval spanning a duration to complete receptions of the at least three transmittals).

In some embodiments, the first node 102-1 may be further configured to: during a first additional time period, receive a first additional transmittal at a first additional arrival time, the first additional transmittal having been transmitted from the second node 102-2 with no time adjustment to the second node clock; during a second additional time period, receive a second additional transmittal at a second additional arrival time, the second additional transmittal having been transmitted from the third node 102-3 with no time adjustment to the third node clock; during a third time additional time period, receive a third additional transmittal at a third additional arrival time, the third additional transmittal having been transmitted from the fourth node 102-4 with no time adjustment to the fourth node clock; the first, second, and third additional transmittals occur in any order (e.g., any order known to the nodes 102-1, 102-2, 102-3, 102-4), wherein an additional cycle of time periods comprises the first, second, and third additional time periods, the first, second, and third additional time periods occurring in any order (e.g., any order known to the nodes 102-1, 102-2, 102-3, 102-4); and/or based at least on (1) the first, second, and third additional arrival times and (2) information associated with any time adjustment to one of the second, third, and fourth node clocks for each of the first, second, and third additional transmittals, update, weight, and/or check the determination of at least one of (a) the relative positions of the second, third, and fourth nodes 102-2, 102-3, 102-4 relative to the position of the first node 102-1 and (b) the relative clock times of the second, third, and fourth node clocks relative to the first node clock.

In some embodiments, the first node 102-1 may be further configured to: during a first additional time period, receive a first additional transmittal at a first additional arrival time, the first additional transmittal having been transmitted from the second node 102-2 with the second node clock time adjusted (e.g., by a transmit time adjustment, which may be calculated based at least on performance of at least one mathematical operation (e.g., at least one algebra operation (e.g., at least one linear algebra operation)) at least on the equation for AT211 from Eq. (1) and/or at least one other equation of Equations (1)-(12) of FIG. 5, where the first additional period is associated the fifth time period and where an exemplary size of the network 100 is four nodes 102) for the first node clock; during the first additional time period, receive a second additional transmittal at a second additional arrival time, the second additional transmittal having been transmitted from the third node 102-3 with the third node clock time adjusted (e.g., by a transmit time adjustment, which may be calculated based at least on performance of at least one mathematical operation (e.g., at least one algebra operation (e.g., at least one linear algebra operation)) at least on the equation for AT311 from Eq. (5) and/or at least one other equation of Equations (1)-(12) of FIG. 5, where the first additional period is the fifth time period and where an exemplary size of the network 100 is four nodes 102) for the first node clock; during a second additional time period, receive a third additional transmittal at a third additional arrival time, the third additional transmittal having been transmitted from the second node 102-2 with no time adjustment to the second node clock; during the second additional time period, receive a fourth additional transmittal at a fourth additional arrival time, the fourth additional transmittal having been transmitted from the third node 102-3 with the third node clock time adjusted (e.g., by a transmit time adjustment, which may be calculated based at least on performance of at least one mathematical operation (e.g., at least one algebra operation (e.g., at least one linear algebra operation)) at least on the equation for AT321 from Eq. (6) and/or at least one other equation of Equations (1)-(12) of FIG. 5, where the second additional period is the sixth time period and where an exemplary size of the network 100 is four nodes 102) for the second node clock; during a third additional time period, receive a fifth additional transmittal at a fifth additional arrival time, the fifth additional transmittal having been transmitted from the second node 102-2 with the second node clock time adjusted (e.g., by a transmit time adjustment, which may be calculated based at least on performance of at least one mathematical operation (e.g., at least one algebra operation (e.g., at least one linear algebra operation)) at least on the equation for AT231 from Eq. (3) and/or at least one other equation of Equations (1)-(12) of FIG. 5, where the third additional period is the seventh time period and where an exemplary size of the network 100 is four nodes 102) for the third node clock; during the third additional time period, receive a sixth additional transmittal at a sixth additional arrival time, the sixth additional transmittal having been transmitted from the third node 102-3 with no time adjustment to the third node clock; wherein the first, second, third, fourth, fifth, and sixth additional transmittals occur in any order (e.g., any order known to the nodes 102-1, 102-2, 102-3, 102-4), wherein an additional cycle of time periods comprises the first, second, and third additional time periods, the first, second, and third additional time periods occurring in any order (e.g., any order known to the nodes 102-1, 102-2, 102-3, 102-4); and/or based at least on (1) the first, second, third, fourth, fifth, and sixth additional arrival times and (2) information associated with any time adjustment to one of the second, third, and fourth node clocks for each of the first, second, third, fourth, fifth, and sixth additional transmittals, update, weight and/or check the determination of at least one of (a) the relative positions of the second, third, and fourth nodes 102-2, 102-3, 102-4 relative to the position of the first node 102-1 and (b) the relative clock times of the second, third, and fourth node clocks relative to the first node clock.

Some embodiments may improve functioning of the network, itself, by reducing a needed bandwidth for determining a network topology, thereby allowing more data to be transmitted across the network. Some embodiments may improve functioning of each node, itself, by reducing an amount of processing operations (and likewise, an amount of power needed) for determining network topology. Some embodiments may improve functioning of each node, itself, by improving an amount of available bandwidth for transmitting data in a network and by reducing an amount of latency for transmitting data in a network.

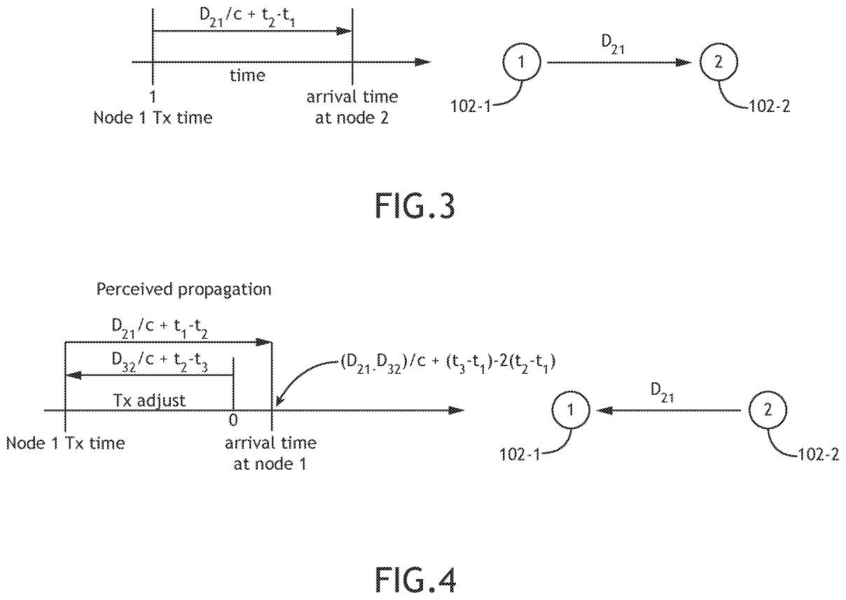

Referring now to FIGS. 3-4, exemplary diagrams associated with an exemplary embodiment of the system of FIGS. 1-2, according to the inventive concepts disclosed herein, are depicted. FIG. 3 shows the first node 102-1 reference transmittal adjusted arrival time at the second node 102-2, where reference node is the first node 102-1, itself, so the first node 102-1 makes no transmit time adjustment. FIG. 4 shows the second node 102-2 reference transmittal adjusted arrival time at the second node 102-2, where reference node is the third node 102-3 for the second node's 102-2 transmittal, so the second node 102-2 makes transmit time adjustment for the arrival time of the third node 102-3 transmission. Here, Dᵢⱼ/c=dᵢⱼ, where Dᵢⱼ is the distance between node i and node j, where dᵢⱼ is the time for light to traverse that distance, where c is the speed of light, and tᵢ is the time when a node i transmits.

In some embodiments, information may be transferred through arrival times (e.g., for acquisition-based transfer efficiencies). For example, 131,072 quantization of arrival times may be use about 17 bits of information (e.g., for packet size efficiencies). For example, all nodes in range can observe these transmission (e.g., for broadcast efficiencies).

As mentioned below, Node 1 may refer to the first node 102-1, Node 2 may refer to the second node 102-2, Node 3 may refer to the third node 102-3, and Node 4 may refer to the fourth node 102-4. The below example uses the following notation for arrival time (AT), where “Tx” refers to “transmit” and “Rx” refers to “receive”: AT (Tx node)→(Rx node) is the arrival time measurement of transmitter node's signal at receiver node due to propagation time and clock times. Here, Dᵢⱼ/c=dᵢⱼ where Dᵢⱼ is the distance between node i and node j and dᵢⱼ is the time for light to traverse that distance. As such, the following equations for arrival times for self-referenced transmit transmittals follows:
AT2→1: =d₂₁+t₁−t₂, Measured by Rx 1, used in node 1's node 2 reference Tx adjust;
AT3→1: =d₃₁+t₁−t₃, Measured by Rx 1, used in node 1's node 3 reference Tx adjust;
AT4→1: =d₄₁+t₁−t₄, Measured by Rx 1, used in node 1's node 4 reference Tx adjust;
AT1→2: =d₁₂+t₂−t₁ Measured by Rx 2, used in node 1's node 1 reference Tx adjust;
AT3→2: =d₃₂+t₂−t₃ Measured by Rx 2, used in node 1's node 3 reference Tx adjust;
AT4→2: =d₄₂+t₂−t₄ Measured by Rx 2, used in node 1's node 4 reference Tx adjust;
AT1→3: =d₁₃+t₃−t₁ Measured by Rx 3, used in node 3's node 1 reference Tx adjust;
AT2→3: =d₂₃+t₃−t₂ Measured by Rx 3, used in node 3's node 2 reference Tx adjust;
AT4→3: =d₄₃+t₃−t₄ Measured by Rx 3, used in node 3's node 4 reference Tx adjust;
AT1→4: =d₁₄+t₄−t₁ Measured by Rx 4, used in node 4's node 1 reference Tx adjust;
AT2→4: =d₂₄+t₄−t₂ Measured by Rx 4, used in node 4's node 2 reference Tx adjust; and
AT3→4: =d₃₄+t₄−t₃ Measured by Rx 4, used in node 4's node 3 reference Tx adjust.

Referring now to FIGS. 5, exemplary equations associated with arrival times for self-referenced and non-self-referenced Tx transmissions associated with an exemplary embodiment of the system of FIGS. 1-2, according to the inventive concepts disclosed herein, are depicted. The below equations use the following notation for arrival time (AT), where “Tx” refers to “transmit” and “Rx” refers to “receive”: ATXYZ: Arrival time of transmittal transmitted by node X, adjusted for node Y, and received by node Z will be denoted as ATXYZ and is a measurement.

$$AT 211 : = ( AT 2 \to 1 ) - ( AT 1 \to 2 ) = - 2 ( {t}_{2} - {t}_{1} ) \qquad Eq . ( 1 )$$

$$AT 221 : = ( AT 2 \to 1 ) = {d}_{21} - ( {t}_{2} - {t}_{1} ) \qquad Eq . ( 2 )$$

$$AT 231 : = ( AT 2 \to 1 ) - ( AT 3 \to 2 ) = ( {d}_{21} - {d}_{32} ) + ( {t}_{3} - {t}_{1} ) - 2 ( {t}_{2} - {t}_{1} ) \qquad Eq . ( 3 )$$

$$AT 241 : = ( AT 2 \to 1 ) - ( AT 4 \to 2 ) = ( {d}_{21} - {d}_{42} ) + ( {t}_{4} - {t}_{1} ) - 2 ( {t}_{2} - {t}_{1} ) \qquad Eq . ( 4 )$$

$$AT 311 : = ( AT 3 \to 1 ) - ( AT 1 \to 3 ) = - 2 ( {t}_{3} - {t}_{1} ) \qquad Eq . ( 5 )$$

$$AT 321 : = ( AT 3 \to 1 ) - ( AT 2 \to 3 ) = ( {d}_{31} - {d}_{23} ) + ( {t}_{2} - {t}_{1} ) - 2 ( {t}_{3} - {t}_{1} ) \qquad Eq . ( 6 )$$

$$AT 331 : = ( AT 3 \to 1 ) = {d}_{31} - ( {t}_{3} - {t}_{1} ) \qquad Eq . ( 7 )$$

$$AT 341 : = ( AT 3 \to 1 ) - ( AT 4 \to 3 ) = ( {d}_{31} - {d}_{34} ) + ( {t}_{4} - {t}_{1} ) - 2 ( {t}_{3} - {t}_{1} ) \qquad Eq . ( 8 )$$

$$AT 411 : = ( AT 4 \to 1 ) - ( AT 1 \to 4 ) = - 2 ( {t}_{4} - {t}_{1} ) \qquad Eq . ( 9 )$$

$$AT 421 : = ( AT 4 \to 1 ) - ( AT 2 \to 4 ) = ( {d}_{41} - {d}_{24} ) + ( {t}_{2} - {t}_{1} ) - 2 ( {t}_{4} - {t}_{1} ) \qquad Eq . ( 10 )$$

$$AT 431 : = ( AT 4 \to 1 ) - ( AT 3 \to 4 ) = ( {d}_{41} - {d}_{34 )} + ( {t}_{3} - {t}_{1} ) - 2 ( {t}_{4} - {t}_{1} ) \qquad Eq . ( 11 )$$

$$AT 441 : = ( AT 4 \to 1 ) = {d}_{41} - ( {t}_{4} - {t}_{1} ) . \qquad Eq . ( 12 )$$

Equations 1-12 include nine unknowns: d₂₁, d₃₁, d₄₁, d₃₂, d₄₂, d₄₃, t₂−t₁, t₃−t₁, t₄−t₁. It should be noted that any difference between dᵢⱼ and dⱼᵢ may be negligible, such that dᵢⱼ=dⱼᵢ may be assumed in some embodiments.

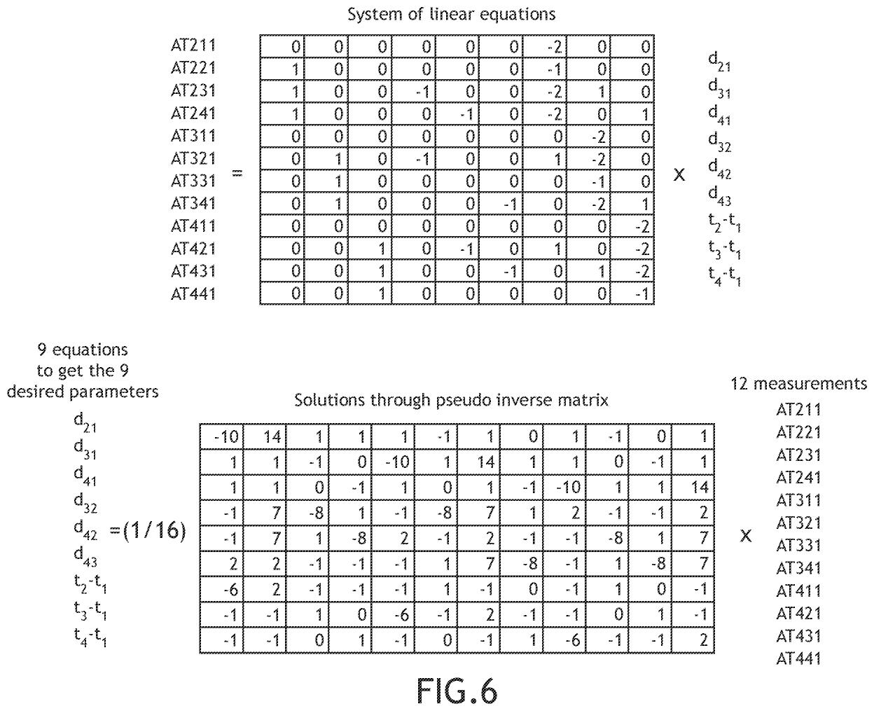

Referring now to FIG. 6, the exemplary equations of FIG. 5 may use exemplary matrices, according to the inventive concepts disclosed herein. A set of linear equations with the Equations 1-12 and nine unknowns can be solved using a standard approach (e.g., Moore-Penrose inverse) using a pseudo-inverse matrix, as shown.

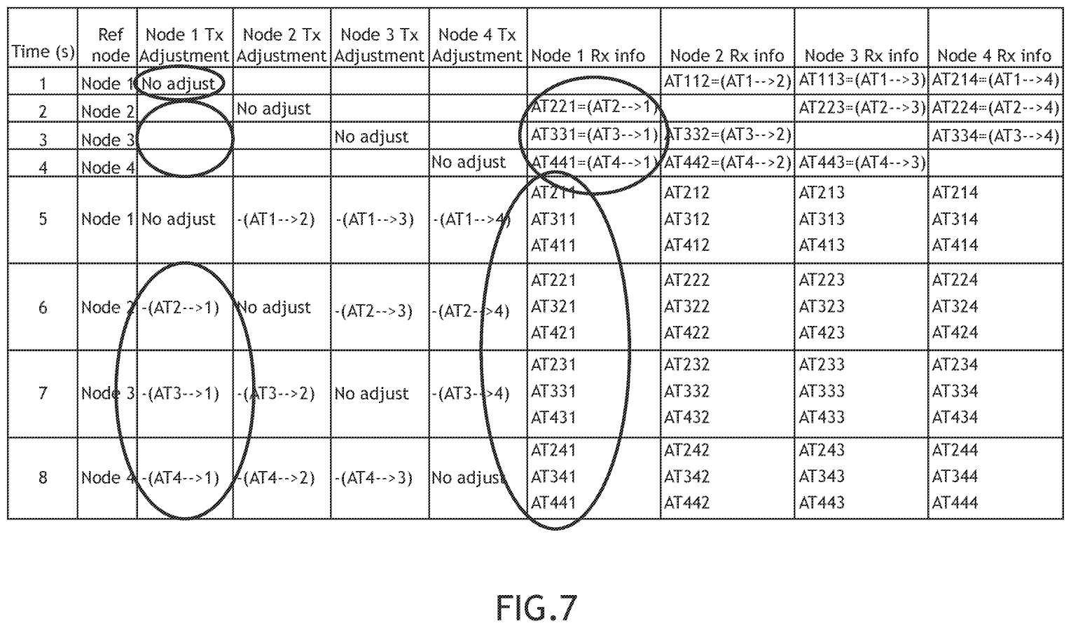

Referring now to FIG. 7, for an exemplary four-node network (e.g., 100), the arrival time of transmittals (e.g., associated with the equations and corresponding matrices of FIGS. 5-6) are shown in an exemplary table, according to the inventive concepts disclosed herein.

In some embodiments, during a first cycle (e.g., which may be a reference cycle) of time periods (e.g., four time periods at t=1,2,3,4 for a four-node network as shown, or more for networks having higher node count), time adjustments are unknown. During the initial cycle, transmissions needing time adjustments are not sent out. As such, empty entries in columns (Node X Tx adjustment) of the table in FIG. 7 indicate no transmission from node X.

Time adjustments are learned in the first cycle (e.g., including t=1,2,3,4) and are used in later cycles (e.g., in later non-reference cycles). For example, time adjustments made in a second cycle (e.g., including t=5,6,7,8) are made according to the reference node and previous measurements in the first cycle (e.g., including t=1,2,3,4). For example, in the second cycle (e.g., including t=5,6,7,8), each transmitter adjusts its transmit time earlier than nominal by an amount equal to the measurement from the first cycle (e.g., by the amount equal to the measurement from t=1,2,3,4) associated with a given reference node. For example, in the second cycle, for t=5 where Node 1 is the reference node, Node 3 transmits earlier than nominal by an amount equal to AT113, which Node 3 measured in t=1, such as shown in the cell shown row t=1 at the column Node 3 Rx info of FIG. 7.

“No adjust” means the signal is transmitted without a time adjustment (e.g., self-reference adjusted).

The final measurements of each of the “Node X Rx info” columns may be multiplied by a pseudo inverse matrix (e.g., of FIG. 6, which is for a first node a four-node network) to find the solutions of other nodes relative to each node 102-1, 102-2, 102-3, 102-4. That is, each node may perform a similar set of operations to determine a network topology.

For example, with respect to the table of FIG. 7, an exemplary timeline follows:

At t=1, node 1 is the reference node so node 1 transmits the frame with no time adjustment. Nodes 2, 3, and 4 have no knowledge of node 1's adjustments so they forgo transmitting. Nodes 2, 3, and 4 receive the Node 1 frame and store the arrival time information to be used as adjustments in the next cycle.

At t=2, node 2 is the reference node so node 2 transmits the frame with no time adjustment. Nodes 1, 3, and 4 have no knowledge of node 2's adjustments so they forgo transmitting. Nodes 1, 3, and 4 receive the Node 2 frame and store the arrival time information to be used as adjustments in the next cycle.

At t=3, node 3 is the reference node so node 3 transmits the frame with no time adjustment. Nodes 1, 2, and 4 have no knowledge of node 3's adjustments so they forgo transmitting. Nodes 1, 2, and 4 receive the Node 3 frame and store the arrival time information to be used as adjustments in the next cycle.

At t=4, node 4 is the reference node so node 4 transmits the frame with no time adjustment. Nodes 1, 2, and 3 have no knowledge of node 4's adjustments so they forgo transmitting. Nodes 1, 2, and 3 receive the Node 4 frame and store the arrival time information to be used as adjustments in the next cycle.

At t=5, node 1 is the reference node so node 1 transmits the frame with no time adjustment. Nodes 2, 3, and 4 have knowledge of node 1's adjustments from the previous cycle and adjust their the transmit time by the arrival time measurement from node 1 from previous cycles. All nodes receive frames from the other three nodes and stores the parameters. See previous chart for details.

At t=6, node 2 is the reference node so node 2 transmits the frame with no time adjustment. Nodes 1, 3, and 4 have knowledge of node 2's adjustments from the previous cycle and adjust their the transmit time by the arrival time measurement from node 2 from previous cycles. All nodes receive frames from the other three nodes and stores the parameters. See previous chart for details.

At t=7, node 3 is the reference node so node 3 transmits the frame with no time adjustment. Nodes 1, 2, and 4 have knowledge of node 3's adjustments from the previous cycle and adjust their the transmit time by the arrival time measurement from node 3 from previous cycles. All nodes receive frames from the other three nodes and stores the parameters. See previous chart for details.

At t=8, node 4 is the reference node so node 4 transmits the frame with no time adjustment. Nodes 1, 2, and 3 have knowledge of node 4's adjustments from the previous cycle and adjust their the transmit time by the arrival time measurement from node 4 from previous cycles. All nodes receive frames from the other three nodes and stores the parameters. See previous chart for details.

Following t=8 set of received info, all information is available to perform the pseudo inverse matrix mathematical operation with measurements to arrive at all link distances and node times.

In some embodiments, each node 102-2, 102-3, 102-4 may be configured to determine relative clock oscillator frequency offsets from deltas in relative times. For example, computations (e.g., GAMT computations) of relative times spaced by 10 seconds may allow the estimation of the offset as

$$( {t}^{21} ( t = 10 ) - {t}^{21} ( t = 0 ) ) / ( 10 - 0 ) ,$$

where t²¹ is (t₂−t₁) and Δf is the relative clock oscillator frequency offset. For this example, if the arrival time resolution is approximately 62.5 ns (e.g., at 16 Msps modulation symbol time), the Δf resolution is 0.0125 parts per million (ppm).

Referring generally to FIGS. 2-7, a four-node network example was shown as solved with an exemplary N=4 (N is the number of nodes in the solution matrix; e.g., up to four node transmittals per time period; one way of choosing all three neighbors; not to be confused with the example network size of four) pseudo inverse solution.

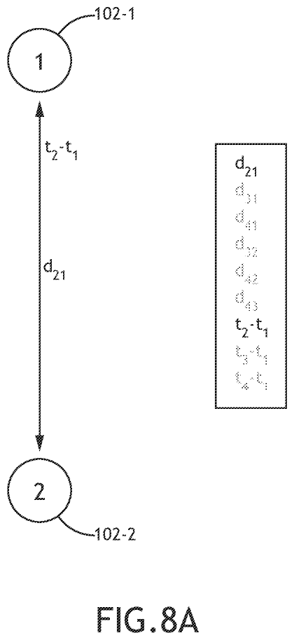

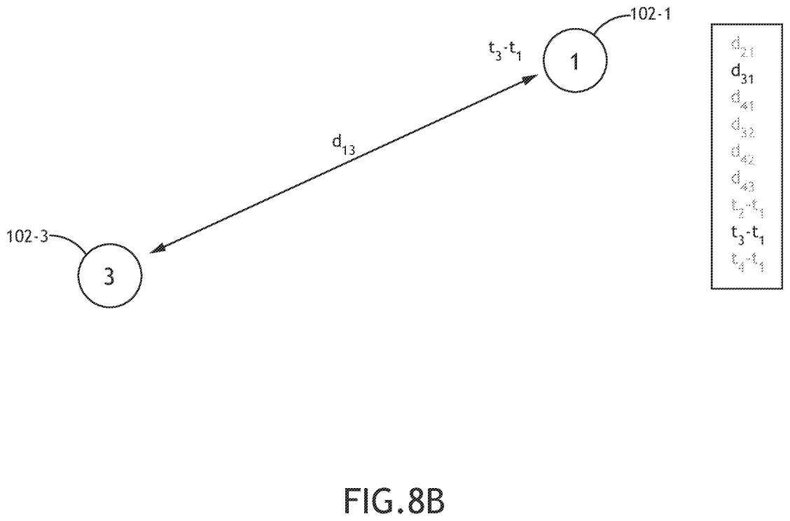

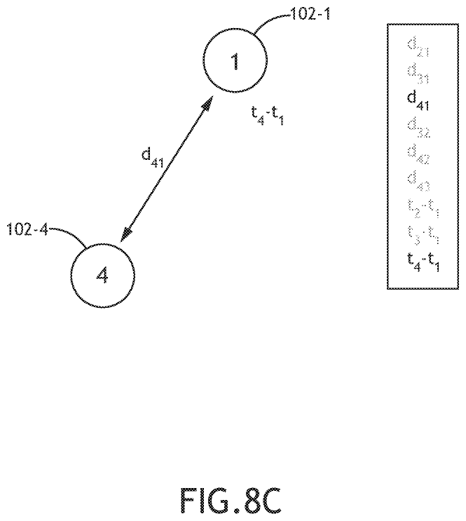

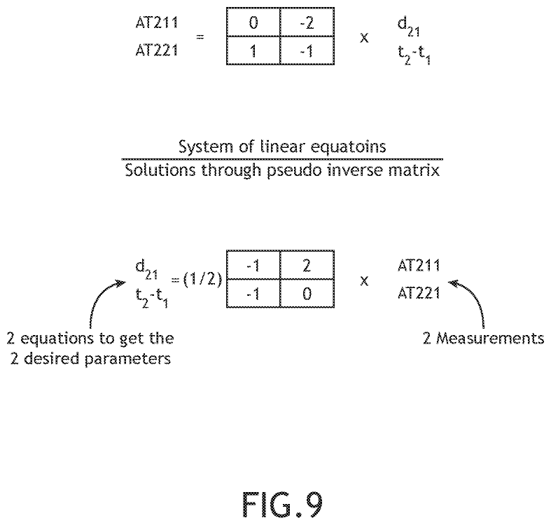

Referring to FIGS. 8A, 8B, 8C, and 9, an exemplary N=2 (N is the number of nodes in the solution matrix; e.g., three ways of choosing one neighbor; not to be confused with the example network size of four) pseudo inverse approach is shown, according to the inventive concepts disclosed herein. The corresponding three subsets of one neighbor can be solved including selected nodes for any of various reasons (e.g., consistency checks (e.g., cyclic consistency checks), invalid data checks, invalid data present, averaging (e.g., weighting) approaches, and/or occasions when not all data is present). If all data is correct, then all approaches arrive at the same answer within measurement resolvability. Exemplary equations associated with arrival times for self-referenced and non-self-referenced transmit transmissions associated with an exemplary embodiment of the system of FIGS. 1-2 are as follows:

$$AT 211 : = ( AT 2 \to 1 ) - ( AT 1 \to 2 ) = - 2 ( {t}_{2} - {t}_{1} )$$

$$AT 221 : = ( AT 2 \to 1 ) = {d}_{21} - ( {t}_{2} - {t}_{1} )$$

There are two equations and two unknowns: d₂₁, t₂-t₁.

It can be assumed that dᵢⱼ=dⱼᵢ.

Referring to FIG. 9, this set of linear equations with two equations and two unknowns can be solved using a standard approach (e.g., Moore-Penrose inverse), such as a pseudo-inverse matrix.

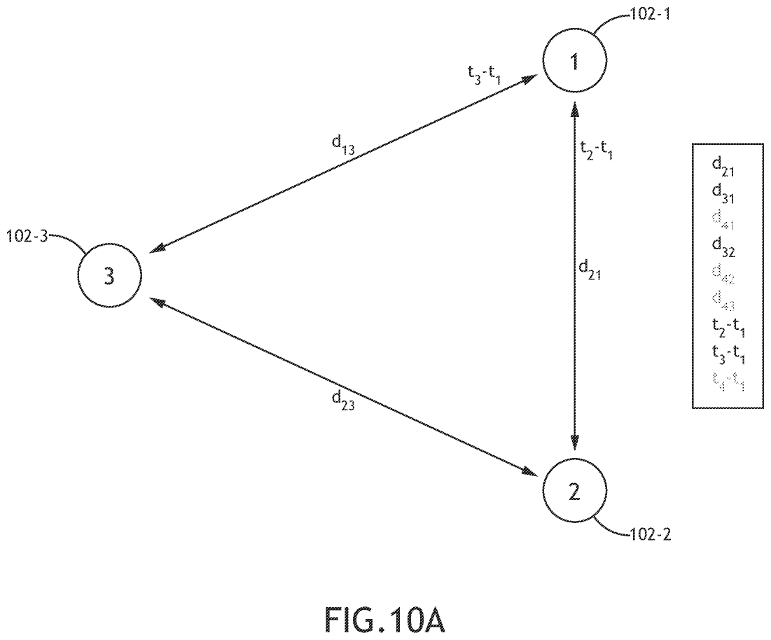

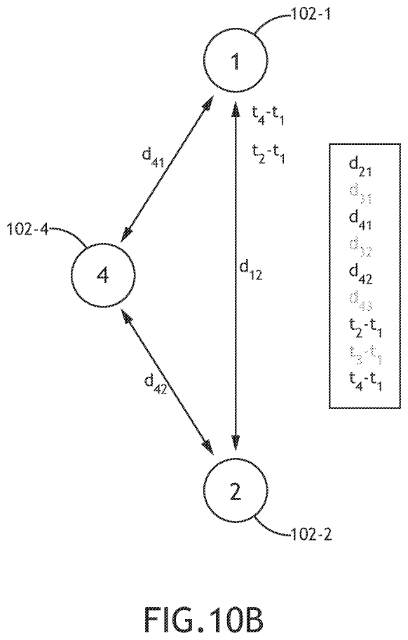

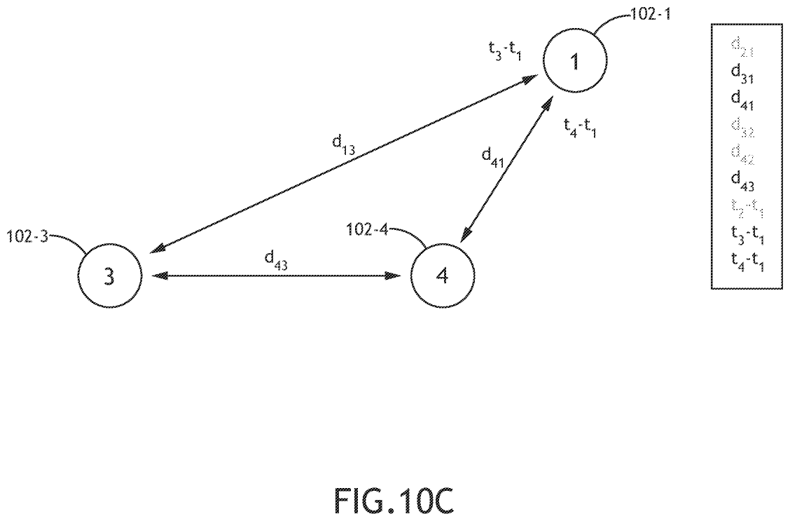

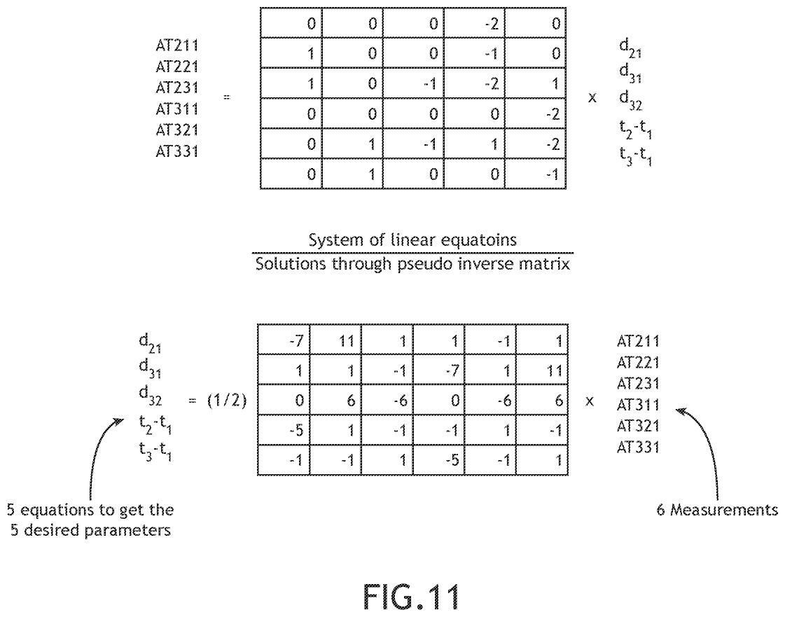

Referring to FIGS. 10A, 10B, 10C, and 11, an exemplary N=3 (N is the number of nodes in the solution matrix; e.g., three ways of excluding one neighbor; not to be confused with the example network size of four) pseudo inverse approach is shown, according to the inventive concepts disclosed herein. The corresponding three subsets of two neighbors can be solved including excluded nodes for any of various reasons (e.g., consistency checks (e.g., cyclic consistency checks), invalid data checks, invalid data present, averaging (e.g., weighting) approaches, and/or occasions when not all data is present). If all data is correct, then all approaches arrive at the same answer within measurement resolvability. Exemplary equations associated with arrival times for self-referenced and non-self-referenced transmit transmissions associated with an exemplary embodiment of the system of FIGS. 1-2 are as follows:

$$AT 211 : = ( AT 2 \to 1 ) - ( AT 1 \to 2 ) = - 2 ( {t}_{2} - {t}_{1} )$$

$$AT 221 : = ( AT 2 \to 1 ) = {d}_{21} - ( {t}_{2} - {t}_{1} )$$

$$AT 231 : = ( AT 2 \to 1 ) - ( AT 3 \to 2 ) = ( {d}_{21} - {d}_{32} ) + ( {t}_{3} - {t}_{1} ) - 2 ( {t}_{2} - {t}_{1} )$$

$$AT 311 : = ( AT 3 \to 1 ) - ( AT 1 \to 3 ) = - 2 ( {t}_{3} - {t}_{1} )$$

$$AT 321 : = ( AT 3 \to 1 ) - ( AT 2 \to 3 ) = ( {d}_{31} - {d}_{23} ) + ( {t}_{2} - {t}_{1} ) - 2 ( {t}_{3} - {t}_{1} )$$

$$AT 331 : = ( AT 3 \to 1 ) = {d}_{31} - ( {t}_{3} - {t}_{1} )$$

There are six equations and five unknowns: d₂₁, d₃₁, d₃₂, t₂−t₁, t₃−t₁.

It can be assumed that dᵢⱼ=dⱼᵢ.

Referring to FIG. 11, this set of linear equations with six equations and five unknowns can be solved using a standard approach (e.g., Moore-Penrose inverse), such as a pseudo-inverse matrix.

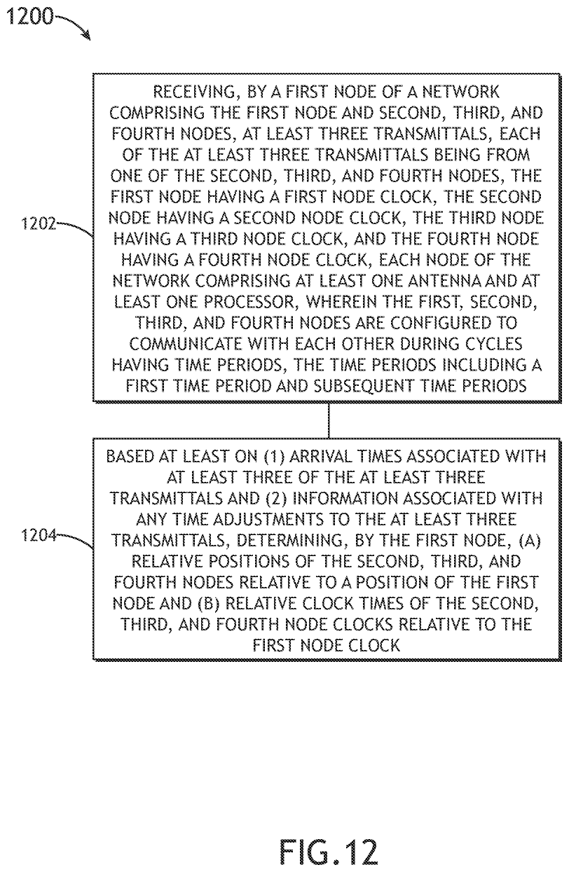

Referring now to FIG. 12, an exemplary embodiment of a method 1200 according to the inventive concepts disclosed herein may include one or more of the following steps. Additionally, for example, some embodiments may include performing one or more instances of the method 1200 iteratively, concurrently, and/or sequentially. Additionally, for example, at least some of the steps of the method 1200 may be performed in parallel and/or concurrently. Additionally, in some embodiments, at least some of the steps of the method 1200 may be performed non-sequentially.

A step 1202 may include receiving, by a first node of a network comprising the first node and second, third, and fourth nodes, at least three transmittals, each of the at least three transmittals being from one of the second, third, and fourth nodes, the first node having a first node clock, the second node having a second node clock, the third node having a third node clock, and the fourth node having a fourth node clock, each node of the network comprising at least one antenna and at least one processor, wherein the first, second, third, and fourth nodes are configured to communicate with each other during cycles of time periods, the time periods including a first time period and subsequent time periods.

A step 1204 may include based at least on (1) arrival times associated with at least three of the at least three transmittals and (2) information associated with any time adjustments to the at least three transmittals, determining, by the first node, (a) relative positions of the second, third, and fourth nodes relative to a position of the first node and (b) relative clock times of the second, third, and fourth node clocks relative to the first node clock.

Further, the method 1200 may include any of the operations disclosed throughout.

As will be appreciated from the above, embodiments of the inventive concepts disclosed herein may be directed to a method and a system including a first node (e.g., of a network) configured to, based at least on (1) arrival times associated with at least three of at least three transmittals and (2) information associated with any time adjustments to at least three transmittals, determine (a) relative positions of second, third, and fourth nodes relative to a position of the first node and (b) relative clock times of second, third, and fourth node clocks relative to the first node clock.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system comprising:
a first node of a network, the network comprising nodes comprising the first node having a first node clock, a second node having a second node clock, a third node having a third node clock, and a fourth node having a fourth node clock, each node of the network comprising at least one antenna and at least one processor, wherein the first, second, third, and fourth nodes are configured to communicate with each other during cycles having time periods, the time periods including a first time period and subsequent time periods, wherein the first node is configured to:
receive at least three transmittals, each of the at least three transmittals being from one of the second, third, and fourth nodes; and
based at least on (1) arrival times associated with at least three of the at least three transmittals and (2) information associated with any time adjustments to the at least three transmittals, determine (a) relative positions of the second, third, and fourth nodes relative to a position of the first node and (b) relative clock times of the second, third, and fourth node clocks relative to the first node clock.

2. The system of claim 1, wherein the first node is further configured to:
during one period of the first time period, a second time period, a third time period, or a fourth time period, receive a first transmittal at a first arrival time, the first transmittal having been transmitted from the second node with no time adjustment to the second node clock, wherein a first cycle of time periods comprises the first, second, third, and fourth time periods, the first, second, third, and fourth time periods occurring in any order;
during another period of the first, second, third, or fourth time periods, receive a second transmittal at a second arrival time, the second transmittal having been transmitted from the third node with no time adjustment to the third node clock;
during a further period of the first, second, third, or fourth time periods, receive a third transmittal at a third arrival time, the third transmittal having been transmitted from the fourth node with no time adjustment to the fourth node clock;
during one period of a fifth time period, a sixth time period, a seventh time period, or an eighth time period:
receive a fourth transmittal at a fourth arrival time, the fourth transmittal having been transmitted from the second node with the second node clock time adjusted for the first node clock;
receive a fifth transmittal at a fifth arrival time, the fifth transmittal having been transmitted from the third node with the third node clock time adjusted for the first node clock; and
receive a sixth transmittal at a sixth arrival time, the sixth transmittal having been transmitted from the fourth node with the fourth node clock time adjusted for the first node clock,
wherein the fourth, fifth, and sixth transmittals occur in any order, wherein a second cycle of time periods comprises the fifth, sixth, seventh, and eighth time periods, the fifth, sixth, seventh, and eighth time periods occurring in any order;
during another period of the fifth, sixth, seventh, or eighth time periods:
receive a seventh transmittal at a seventh arrival time, the seventh transmittal having been transmitted from the second node with no time adjustment to the second node clock;
receive an eighth transmittal at an eighth arrival time, the eighth transmittal having been transmitted from the third node with the third node clock time adjusted for the second node clock; and
receive a ninth transmittal at a ninth arrival time, the ninth transmittal having been transmitted from the fourth node with the fourth node clock time adjusted for the second node clock,
wherein the seventh, eighth, and ninth transmittals occur in any order;
during a further period of the fifth, sixth, seventh, or eighth time periods:
receive a tenth transmittal at a tenth arrival time, the tenth transmittal having been transmitted from the second node with the second node clock time adjusted for the third node clock;
receive an eleventh transmittal at an eleventh arrival time, the eleventh transmittal having been transmitted from the third node with no time adjustment to the third node clock; and
receive a twelfth transmittal at a twelfth arrival time, the twelfth transmittal having been transmitted from the fourth node with the fourth node clock time adjusted for the third node clock,
wherein the tenth, eleventh, and twelfth transmittals occur in any order;
during an additional period of the fifth, sixth, seventh, or eighth time periods:
receive a thirteenth transmittal at a thirteenth arrival time, the thirteenth transmittal having been transmitted from the second node with the second node clock time adjusted for the fourth node clock;
receive a fourteenth transmittal at a fourteenth arrival time, the fourteenth transmittal having been transmitted from the third node with the third node clock time adjusted for the fourth node clock; and
receive a fifteenth transmittal at a fifteenth arrival time, the fifteenth transmittal having been transmitted from the fourth node with no time adjustment to the fourth node clock,
wherein the thirteenth, fourteenth, and fifteenth transmittals occur in any order;
wherein the at least three transmittals are the fourth, fifth, sixth, seventh, eighth, ninth, tenth, eleventh, twelfth, thirteenth, fourteenth, and fifteenth transmittals; and
based at least on (1) at least three of the fourth, fifth, sixth, seventh, eighth, ninth, tenth, eleventh, twelfth, thirteenth, fourteenth, and fifteenth arrival times and (2) information associated with any time adjustment to one of the second, third, and fourth node clocks for each of at least three of the fourth, fifth, sixth, seventh, eighth, ninth, tenth, eleventh, twelfth, thirteenth, fourteenth, and fifteenth transmittals, determine (a) the relative positions of the second, third, and fourth nodes relative to the position of the first node and (b) the relative clock times of the second, third, and fourth node clocks relative to the first node clock.

3. The system of claim 2, wherein the at least three of the fourth, fifth, sixth, seventh, eighth, ninth, tenth, eleventh, twelfth, thirteenth, fourteenth, and fifteenth arrival times are the seventh, eleventh, and fifteenth arrival times, wherein the at least three of the fourth, fifth, sixth, seventh, eighth, ninth, tenth, eleventh, twelfth, thirteenth, fourteenth, and fifteenth transmittals are the seventh, eleventh, and fifteenth transmittals.

4. The system of claim 2, wherein the at least three of the fourth, fifth, sixth, seventh, eighth, ninth, tenth, eleventh, twelfth, thirteenth, fourteenth, and fifteenth arrival times are the fourth, fifth, seventh, eighth, tenth, and eleventh arrival times, wherein the at least three of the fourth, fifth, sixth, seventh, eighth, ninth, tenth, eleventh, twelfth, thirteenth, fourteenth, and fifteenth transmittals are the fourth, fifth, seventh, eighth, tenth, and eleventh transmittals.

5. The system of claim 2, wherein the at least three of the fourth, fifth, sixth, seventh, eighth, ninth, tenth, eleventh, twelfth, thirteenth, fourteenth, and fifteenth arrival times are the fourth, fifth, sixth, seventh, eighth, ninth, tenth, eleventh, twelfth, thirteenth, fourteenth, and fifteenth arrival times, wherein the at least three of the fourth, fifth, sixth, seventh, eighth, ninth, tenth, eleventh, twelfth, thirteenth, fourteenth, and fifteenth transmittals are the fourth, fifth, sixth, seventh, eighth, ninth, tenth, eleventh, twelfth, thirteenth, fourteenth, and fifteenth transmittals.

6. The system of claim 2, wherein the first node is further configured to:
based at least on the relative positions and the relative clock times, at least one of (a) output instructions to adjust communication parameters of the first node, (b) output instructions to adjust operational parameters of at least one sub-system or at least one sensor of the first node, (c) output instructions to display at least one graphical image including information of the at least one of the relative positions or the relative clock times, (d) output instructions to navigate the first node, (e) output instructions to communicate with the second node, the third node, fourth node, and/or another node of the network, (f) authenticate position information obtained from at least one navigation system, (g) authenticate time information obtained from at least one time system, (h) output instructions to the second node, the third node, the fourth node, and/or the other node of the network to support controlling communications with the first node through the second node, the third node, the fourth node, and/or the other node, (i) output a position location information (PLI) message, (j) output audio data including information of the at least one of the relative positions or the relative clock times, or (k) output information of at least one of position or time, the information based at least on at least one of the relative positions or the relative clock times.

7. The system of claim 6, wherein the network further comprises the other node.

8. The system of claim 2, wherein each of the fourth, fifth, sixth, seventh, eighth, ninth, tenth, eleventh, twelfth, thirteenth, fourteenth, and fifteenth arrival times depends on (a) a propagation delay of a corresponding transmittal of the fourth, fifth, sixth, seventh, eighth, ninth, tenth, eleventh, twelfth, thirteenth, fourteenth, and fifteenth transmittals and (b) any time adjustment to one clock of the second, third, or fourth node clocks of said corresponding transmittal of the fourth, fifth, sixth, seventh, eighth, ninth, tenth, eleventh, twelfth, thirteenth, fourteenth, and fifteenth transmittals.

9. The system of claim 2, wherein each of the fourth, fifth, sixth, seventh, eighth, ninth, tenth, eleventh, twelfth, thirteenth, fourteenth, and fifteenth transmittals is or includes a frame.

10. The system of claim 2, wherein each frame is a data frame or an acquisition frame.

11. The system of claim 2, wherein each frame includes known symbols.

12. The system of claim 1, wherein the first node is further configured to perform operations to solve a system of linear equations to determine (a) the relative positions and (b) the relative clock times.

13. The system of claim 12, wherein the first node is further configured to perform the operations using at least one matrix to solve the system of the linear equations to determine (a) the relative positions and (b) the relative clock times.

14. The system of claim 13, wherein the at least one matrix comprises a pseudo inverse matrix.

15. The system of claim 1, wherein the first node lacks a reliable global navigation satellite system (GNSS) input at least for a time interval spanning a duration to complete receptions of the at least three transmittals.

16. The system of claim 1, wherein the first node lacks any global navigation satellite system (GNSS) input at least for a time interval a duration to complete receptions of the at least three transmittals.

17. The system of claim 2, wherein the first node is further configured to:
during a first additional time period, receive a first additional transmittal at a first additional arrival time, the first additional transmittal having been transmitted from the second node with no time adjustment to the second node clock;
during a second additional time period, receive a second additional transmittal at a second additional arrival time, the second additional transmittal having been transmitted from the third node with no time adjustment to the third node clock;
during a third additional time period, receive a third additional transmittal at a third additional arrival time, the third additional transmittal having been transmitted from the fourth node with no time adjustment to the fourth node clock;
wherein the first, second, and third additional transmittals occur in any order, wherein an additional cycle of time periods comprises the first, second, and third additional time periods, the first, second, and third additional time periods occurring in any order; and
based at least on (1) the first, second, and third additional arrival times and (2) information associated with any time adjustment to one of the second, third, and fourth node clocks for each of the first, second, and third additional transmittals, update, weight, and/or check the determination of at least one of (a) the relative positions of the second, third, and fourth nodes relative to the position of the first node and (b) the relative clock times of the second, third, and fourth node clocks relative to the first node clock.

18. The system of claim 2, wherein the first node is further configured to:
during a first additional time period, receive a first additional transmittal at a first additional arrival time, the first additional transmittal having been transmitted from the second node with the second node clock time adjusted for the first node clock;
during the first additional time period, receive a second additional transmittal at a second additional arrival time, the second additional transmittal having been transmitted from the third node with the third node clock time adjusted for the first node clock;
during a second additional time period, receive a third additional transmittal at a third additional arrival time, the third additional transmittal having been transmitted from the second node with no time adjustment to the second node clock;
during the second additional time period, receive a fourth additional transmittal at a fourth additional arrival time, the fourth additional transmittal having been transmitted from the third node with the third node clock time adjusted for the second node clock;
during a third additional time period, receive a fifth additional transmittal at a fifth additional arrival time, the fifth additional transmittal having been transmitted from the second node with the second node clock time adjusted for the third node clock;
during the third additional time period, receive a sixth additional transmittal at a sixth additional arrival time, the sixth additional transmittal having been transmitted from the third node with no time adjustment to the third node clock;
wherein the first, second, third, fourth, fifth, and sixth additional transmittals occur in any order, wherein an additional cycle of time periods comprises the first, second, and third additional time periods, the first, second, and third additional time periods occurring in any order; and
based at least on (1) the first, second, third, fourth, fifth, and sixth additional arrival times and (2) information associated with any time adjustment to one of the second, third, and fourth node clocks for each of the first, second, third, fourth, fifth, and sixth additional transmittals, update, weight and/or check the determination of at least one of (a) the relative positions of the second, third, and fourth nodes relative to the position of the first node and (b) the relative clock times of the second, third, and fourth node clocks relative to the first node clock.

19. The system of claim 2, wherein the first node is further configured to:
during the first time period, transmit a first first-node transmittal at a first first-node time, wherein the first first-node transmittal has no time adjustment to the first node clock.

20. A method, comprising:
receiving, by a first node of a network comprising the first node and second, third, and fourth nodes, at least three transmittals, each of the at least three transmittals being from one of the second, third, and fourth nodes, the first node having a first node clock, the second node having a second node clock, the third node having a third node clock, and the fourth node having a fourth node clock, each node of the network comprising at least one antenna and at least one processor, wherein the first, second, third, and fourth nodes are configured to communicate with each other during cycles having time periods, the time periods including a first time period and subsequent time periods; and
based at least on (1) arrival times associated with at least three of the at least three transmittals and (2) information associated with any time adjustments to the at least three transmittals, determining, by the first node, (a) relative positions of the second, third, and fourth nodes relative to a position of the first node and (b) relative clock times of the second, third, and fourth node clocks relative to the first node clock.
